(19) United States
(12) Patent Application Publication
(10) Pub. No.: US 2025/0389127 A1
(43) Pub. Date: Dec. 25, 2025

(54) DOOR SETS, AND METHODS OF INSTALLING DOOR SETS

(71) Applicant: Pinnacle Carpentry and Roofing Ltd, Isleworth Middlesex (GB)

(72) Inventor: Florin STOICA, Isleworth Middlesex (GB)

(21) Appl. No.: 19/188,461

(22) Filed: Apr. 24, 2025

(30) Foreign Application Priority Data
Jun. 20, 2024 (GB) 2408891.6

(51) Int. Cl. E04F 21/00

(52) U.S. Cl. CPC E04F 21/0015

(57) ABSTRACT

A door set for installation in a doorway in a wall. The door set comprises a door liner arranged to be mounted by its outer edges to the wall adjacent the doorway, and further arranged to have a door movably mounted to an inner edge; and at least one door alignment tool, comprising a base plate, at least one prong extending from a face of the base plate, and at least one alignment fixing on the base plate. The at least one prong is arranged to be inserted into a corresponding at least one bore in one of the door liner and the wall. The door alignment tool is arranged to be removably and adjustably secured to the other of the door liner and the wall adjacent the doorway using the alignment fixing.

### FIELD OF THE INVENTION

The present invention concerns door sets for installation in a doorway in a wall. More particularly, but not exclusively, the invention concerns door sets comprising a door liner, a door, and at least one door alignment tool. The invention also concerns methods of installing a door set in a doorway in a wall.

### BACKGROUND OF THE INVENTION

Door sets are often used to allow easier and more efficient installation of doors. A door set usually includes a door, and a door liner that surrounds the door, to which the door is mounted on hinges. The door set will generally be pre-assembled in a factory, and then transported to the site where it is to be installed. To install the door set in a doorway, the door liner is mounted to the wall adjacent the doorway. Usually, an architrave is then installed over the door liner and adjacent wall, so that they are hidden.

It is usually important that doors installed using door sets provide a suitable barrier to fire. Once a door set has been installed, a fire strip may be applied between the door and the door liner. Alternatively, often a door set will have the first strip pre-installed. In the event of fire, the fire strip melts and adheres the door to the door liner, creating a fire-proof seal. If a fire is present on one side of a doorway (for example, in the interior of a room with a doorway), there will be a pressure differential exists between the sides of the doorway. The fire-proof seal between the door and the lining prevents the door from being distorted, improving the fire resistance of the door.

For the fire strip to adhere the door to the door strip, the fire strip must be heated to above its melting point. This requires a suitable gap between the door and door seal to allow the ingress of hot air in the event of a fire. For improved fire resistance, the fire strip must uniformly adhere the edge of the door to the door liner. Ideally, there is a uniform gap between the door frame and the door seal of between 2 mm and 4 mm wide.

During installation, an installer must therefore try to ensure that the gap between the door and the door liner is uniform and within the allowable width. To allow this, known door sets include alignment brackets that are mounted at least partially within the door liner of the door set. During installation, the installer secures the alignment bracket to the wall adjacent the doorway. The alignment bracket comprises holes through which the alignment bracket is adjustably secured to the wall by screws or nails. The installer first ensures the gap between the door liner and the door is of an acceptable width, then secures the alignment bracket to the wall.

As the alignment bracket is at least partially mounted within the door liner, it cannot be removed from the door set after installation. The alignment brackets are therefore single-use. This causes a waste of materials, particularly as usually multiple alignment brackets are required for a single door set. Further, mounting the alignment bracket within the door liner can be technically difficult, and may result in the door liner becoming split. Additionally, the alignment bracket protrudes from the door liner, meaning that architrave installed to cover the door liner needs to have a recess in its surface facing the door liner into which the protruding alignment bracket can extend. This can require special architrave to be used, and increases the complication and cost of installing the door set.

The present invention seeks to mitigate the above-mentioned problems. Alternatively or additionally, the present invention seeks to provide improved door sets and improved methods of installing door sets.

### SUMMARY OF THE INVENTION

The present invention provides, according to a first aspect, a door set for installation in a doorway in a wall, comprising:

a door liner arranged to be mounted by its outer edges to the wall adjacent the doorway, and further arranged to have a door movably mounted to an inner edge;

at least one door alignment tool, comprising:
a base plate;
at least one prong extending from a face of the base plate; and
at least one alignment fixing on the base plate;

wherein the at least one prong is arranged to be inserted into a corresponding at least one bore in one of the door liner and the wall, and wherein the door alignment tool is arranged to be removably and adjustably secured to the other of the door liner and the wall adjacent the doorway using the alignment fixing.

By having a door alignment tool with at least one prong that extends into a bore in the door liner or wall, the door alignment tool can easily be mounted on the door liner or wall, with the prong keeping the door alignment tool in position with respect to the door liner or wall. The alignment fixing can then be used to position the door alignment tool in the required position with respect to the other of the door liner and the wall, so positioning the door liner as required with respect to the wall. Once the door liner is in the required position, it can be permanently fixed to the wall in the required position, for example by screwing the door liner to the wall through its inside edge. The door alignment tool can then be removed. This allows the door alignment tool to be used for installation of further door sets. In addition, unlike with known door sets, the door liner is fixed in position to the wall without any bracket extending from the wall, meaning that a conventional architrave without any recess can be used to cover the door liner.

The door set may further comprise a door movably mounted to the inner edge of the door liner.

The at least one door alignment tool may further comprise a second prong extending from the face of the base plate, wherein the second prong is arranged to be inserted into a corresponding second bore in the one of the door liner and the wall. Having two or more prongs prevents the door alignment tool rotating about the prongs, allowing easier and more reliable positioning of the door liner with respect to the wall. Additionally, it allows forces exerted by or on the door alignment tool to be shared between the prongs, reducing the risk of the door alignment tool failing.

The door alignment tool further may further comprise a securement fixing on the base plate, wherein the door alignment tool is arranged to be removably secured to the one of the door liner and the wall using the securement fixing. This helps ensure the door alignment tool remains in place during installation of the door set. When the door alignment tool comprises two prongs, the securement fixing may be located between the prongs. Providing the securement fixing between two prongs allows forces exerted on or by the prongs as the door alignment tool is used to align the door liner to be more evenly distributed across the door alignment tool, meaning the door alignment tool is less likely to fail. The securement fixing may comprise a hole in the base plate through which the door alignment tool is arranged to be removably secured to the one of the door liner and the wall by a screw.

The alignment fixing may comprise at least one hole in the base plate through which the door alignment tool is arranged to be removably and adjustably secured to the other of the door liner and the wall by a screw. The at least one hole may be an elongate slot. The alignment fixing may further comprise a second elongate slot, wherein the elongate axis of the first elongate slot is at a non-zero angle with respect to the elongate axis of the second elongate slot. This allows easier and more reliable positioning of the door alignment tool with respect to the other of the door liner and the wall, by tightening and loosening the screws through the first elongate slot and second elongate slot as required.

The at least one prong may be adjacent a first end of the base plate, and the at least one an alignment fixing adjacent a second end of the base plate.

The door liner may comprise the at least one bore. This allows the door liner to be provided with the bore to be pre-drilled, so that the bore does not need to be drilled by the installer during installation of the door, which could be done incorrectly, particularly where the door alignment tool comprises two prongs, so two correctly-spaced bores are required.

The door set may comprise a plurality of door alignment tools. This allows the door liner to be aligned in the required position in a plurality of locations, allows the door liner to be aligned more evenly, and reduces the stresses exerted on the door liner during alignment.

The present invention provides, according to a second aspect, a method of installing the door set of any preceding claim in a doorway in a wall, comprising the steps of:

inserting the at least one prong of the at least one door alignment tool into the corresponding at least one bore in the one of the door liner and the wall;

removably securing the door alignment tool to the other of the door liner and the wall using the at least one alignment fixing;

positioning the door liner with respect to the wall using the at least one alignment fixing;

mounting the outer edge of the door liner to the wall; and

removing the at least one door alignment tool from the door liner and the wall.

The door set may further comprise a door, wherein the step of positioning the door liner with respect to the wall comprises:

positioning the door liner and the door within the doorway such that a gap exists between the door liner and the door; and

aligning the door liner and the door and such that the gap between the door liner and door is of uniform width.

The door alignment tool may further comprise a securement fixing, wherein the method comprises, subsequent to the step of inserting the at least one prong of the at least one door alignment tool, the step of:

removably securing the door alignment tool to the one of the door liner and the wall using the securement fixing.

Packing material may be inserted in the gap between the door liner and the wall as part of the step of positioning the door liner with respect to the wall. The packing material may extend the whole depth of the door liner, and may be in line with or very close to the screw or other fixing by which the door liner is mounted to the wall. The use of packing material allows particularly reliable and accurate positioning of the door set with respect to the wall.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows a front-on view of a door set according to a first embodiment of the invention, prior to aligning in position in a doorway;

FIGS. 2a and 2b show perspective views of a door alignment tool of the door set of the first embodiment;

FIG. 3 shows a flow chart of a method of installing a door set according to an embodiment of the invention;

FIG. 4 shows a perspective view of the door set of the first embodiment, with door alignment tool mounted on the door liner;

FIG. 5 shows a front-on view of the door set of the first embodiment following positioning in the doorway; and

FIG. 6 shows a front-on view of the door set with architrave.

### DETAILED DESCRIPTION

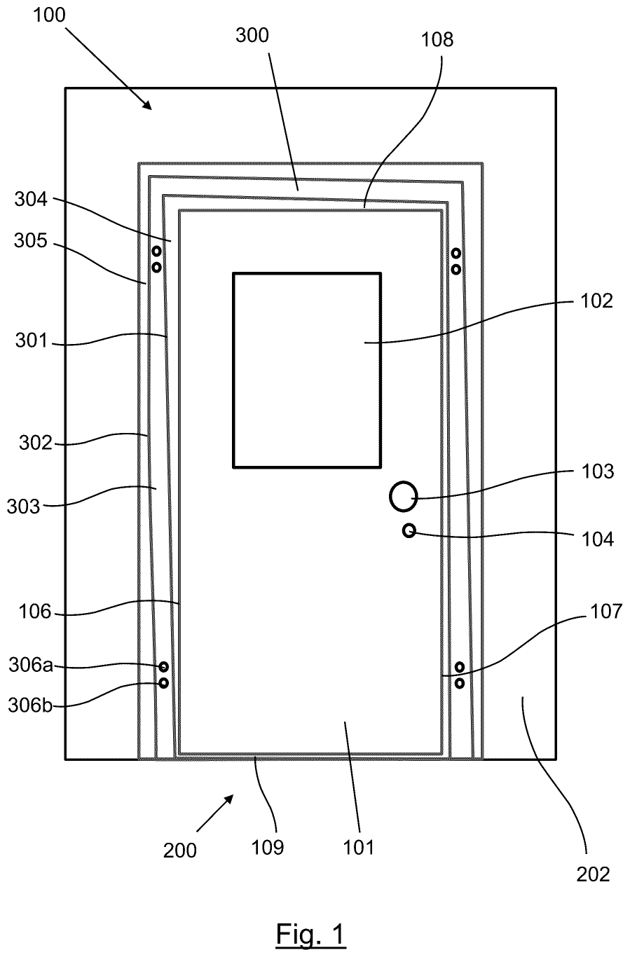

A door set in accordance with a first embodiment of the invention is now described with reference to FIGS. 1 to 5. As can be seen in FIG. 1, the door set 100 is installed in a doorway 200 in a wall 202. The door set comprises a door 101, having a first side edge 106, a second side edge 107, a top edge 108 and a bottom edge 109. The door 101 comprises a window 102, a handle 103 and a lock 104.

The door set 100 further comprises a door liner 300, having a face 303 extending between an inner edge 301 and an outer edge 302. The door liner 300 is positioned between the door 101 and the wall 202 adjacent the doorway 200. The door liner 300 extends along the entire edge of each of the first side edge 106, the second side edge 107 and the top edge 108 of the door 101. In other embodiments, the door liner may also extend between the bottom edge of the door and the surface of the floor adjacent to the doorway. Four sets of two bores 306a, 306b (only one set of which is numbered in the figures) are provided in the face 303 of the door liner 300, two sets on opposite sides of the door liner 300 near the bottom of the doorway 200, and two sets on opposite sides of the door liner 300 near the top of the doorway 200. A further four sets of two bores 306a, 306b (not shown) are provided in the opposite face of the door liner 300. The door 101 is movably mounted by hinges (not shown) to the inner edge 301 of the door liner 300. In FIG. 1 the door set 100 has not yet been aligned in position within the doorway 200, and so as can be seen there is the inner gap 304 between the inner edge 301 of the door liner 300 and the edges 106, 107, 108 of the door 101 is not of uniform width. Similarly, there is a non-uniform outer gap 305 between the outer edge 302 of the door liner 300 and the wall 202 adjacent the doorway 200.

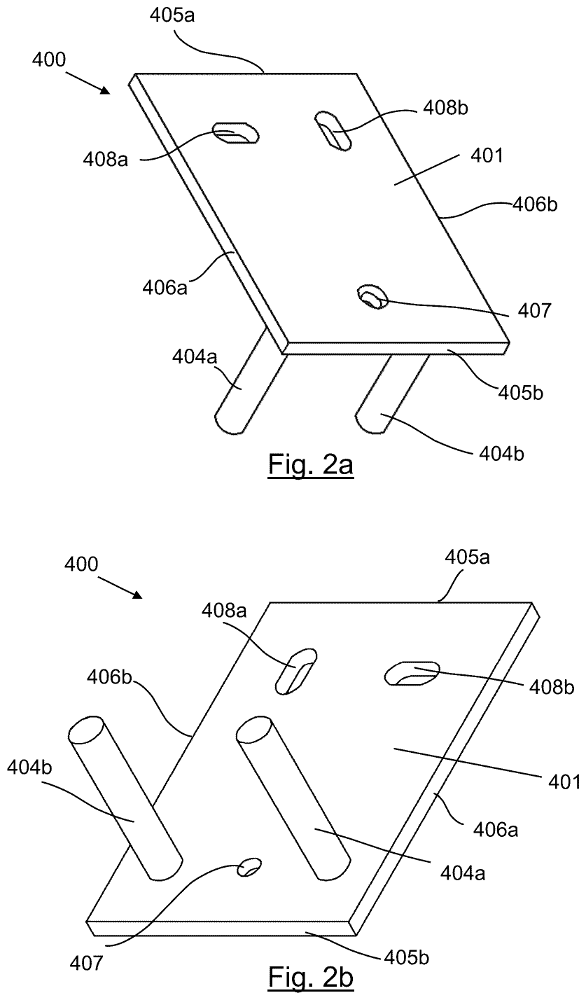

A door alignment tool 400 of the door set 100 is shown in FIGS. 2a and 2b. The door alignment tool 400 comprises a rectangular base plate 401, with long edges 406a, 406b and short edges 405a, 405b. Two cylindrical prongs 404a, 404b extend perpendicularly from one end of one face of the base plate 401, towards the short edge 405b. The prongs 404a, 404b are dimensioned and positioned on the base plate 401 so to correspond with the two bores 306a, 306b of sets of bores in the door liner 300, i.e. the prongs 404a, 404b are of corresponding size to the bores 306a, 306b, and spaced the same distance apart.

The door alignment tool 400 further comprises a hole 407 through the base plate 407 between the prongs 404a, 404b. The hole 407 provides a securement fixing for the door alignment tool 400, as described in more detail below.

The door alignment tool 400 further comprises elongate slots 408a, 408b through the other end of the base plate 401 from the prongs 404a, 404b, towards the other short edge 405a. The first elongate slot 408a has its elongate axis parallel to the long edges 406a, 406b of the base plate 401, while the elongate slot 408a has its elongate axis parallel to the short edges 405a, 405b of the base plate 401, so the elongate axis of the first elongate slot 408a is perpendicular to the elongate axis of the second elongate slot 408b.

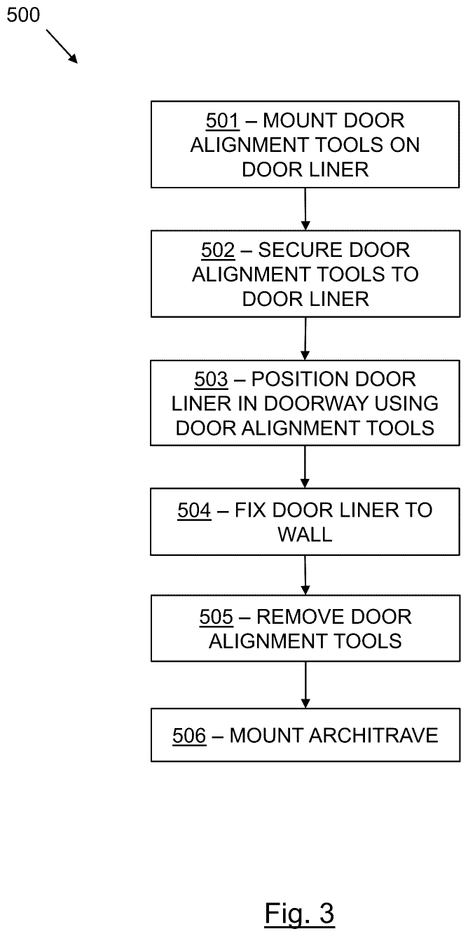

A method of installing the door set 100 in the doorway 200 in accordance with an embodiment of the invention is now described with reference to the flowchart 500 of FIG. 3.

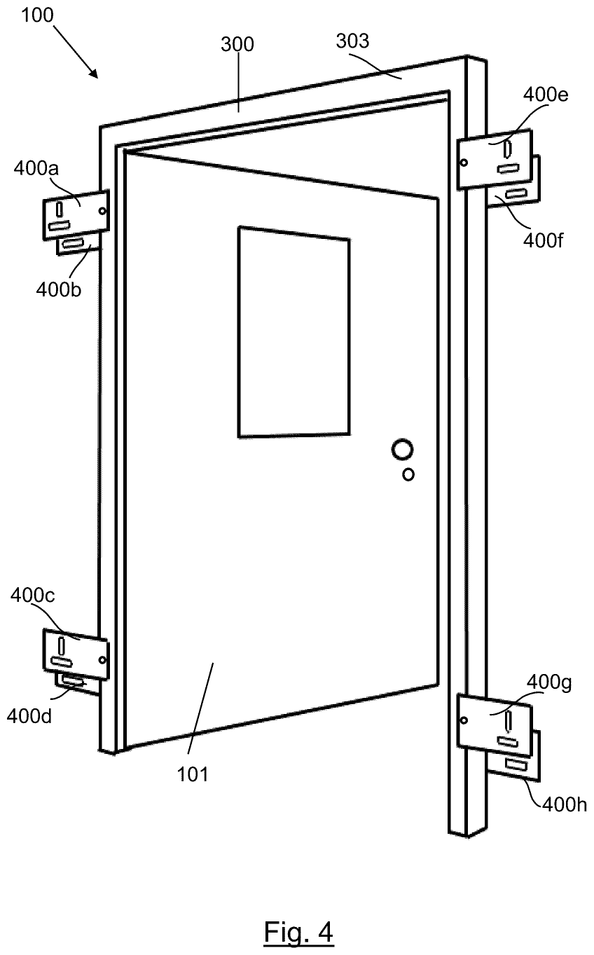

First, a plurality of door alignment tools 400 are mounted on the door liner 300 (step 501). One door alignment tool 400 is provided for each set of bores 306a, 306b of the door liner 300. In each case, the prongs 404a, 404b of the door alignment tool 400 are inserted into the 306a, 306b. The resulting door set 100 can be seen in FIG. 4, in which the wall 200 is omitted for clarity. As can be seen, four door alignment tools 400a, 400c, 400e, 400g are mounted on one side of the door liner 300, using the set of bores 306a, 306b in the face 303 of the door liner 300. A further four door alignment tools 400b, 400d, 400f, 400h are mounted on the other side of the door liner 300, using the set of bores 306a, 306b on its other face.

Next, the plurality of door alignment tools 400 are secured to the door liner 300 (step 502). This is done by screwing a screw through the hole 407 of each door alignment tool 400 into the door liner 300.

The door liner 300 is then aligned in the required position within the doorway 200 (step 503), i.e. so that the door liner 300 is aligned within the doorway 200 such that the width of the inner gap 304 between the inner edge 301 of the door liner 300 and the edge 106, 107, 108 of the door 101 is uniform. This is done by inserting packing material (not shown) in the gap between the door liner 500 and the doorway 200, to position the door liner 500 with respect to the doorway 200. The packing material extends the whole depth of the door liner, and is positioned in line the plurality of door alignment tools 400. The plurality of door alignment tools 400 are then secured to the wall 202 adjacent to the doorway 200, by screwing screws through the elongate slots 408a, 408b of each door alignment tools 400. As the elongate slots 408a, 408b are elongate, the door liner 300 can be moved and fixed within the doorway 200 as required, by loosening and tightening respectively the screws through the elongate slots 408a, 408b. The door liner 300 is then held in position within the doorway 200 by the door alignment tools 400, specifically by the prongs 404a, 404b that are inserted into the bores 306a, 306b in the door liner 300, and the screws securing the base plate 401 through the elongate slots 408a, 408b to the wall 202.

When the door liner 300 is in the required position, the door liner 300 is permanently fixed in position to the wall 202 (step 504), by screwing it to the wall 202 through its inside edge (i.e. the edge that faces the door 100 when closed). The door liner 300 is screwed to the wall 202 at the locations where a door alignment tool 400 is removably mounted.

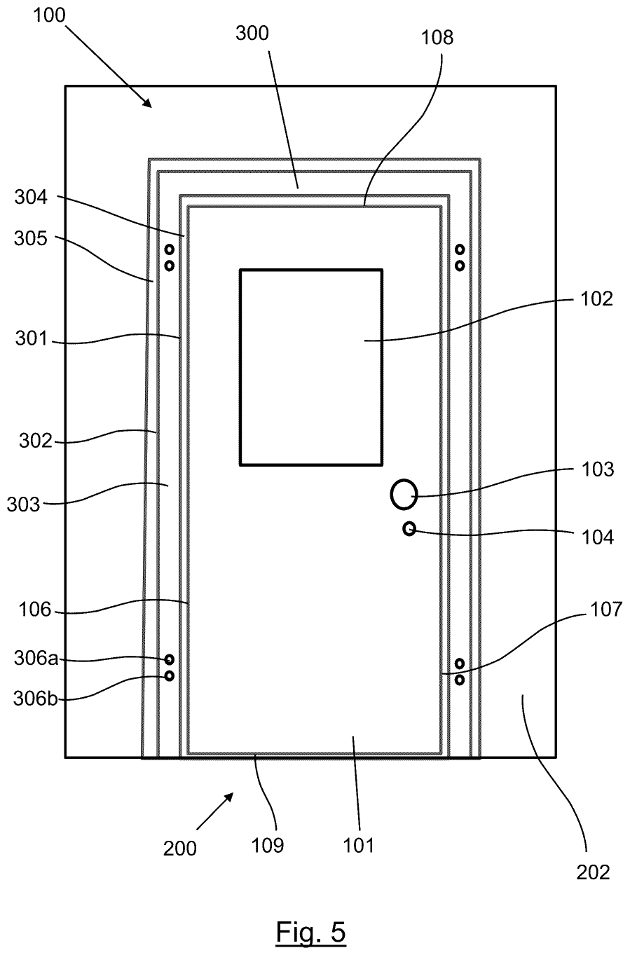

The door alignment tools 400 are then removed from the door liner 300 (step 505), by unscrewing the screws through the hole 407 and the elongate slots 408a, 408b, and removing the prongs 404a, 404b from the elongate slots 408a, 408b. This then gives the arrangement shown in FIG. 5, in which it can be seen that the door set 100 is aligned within the doorway 200, with the inner gap 304 between the inner edge 301 of the door liner 300 and the door 101 being of uniform width. (The screws permanently fixing the door liner 300 in position to the wall 202 are not shown.) Further, the door alignment tools 400 can then be reused for the installation of a further door set.

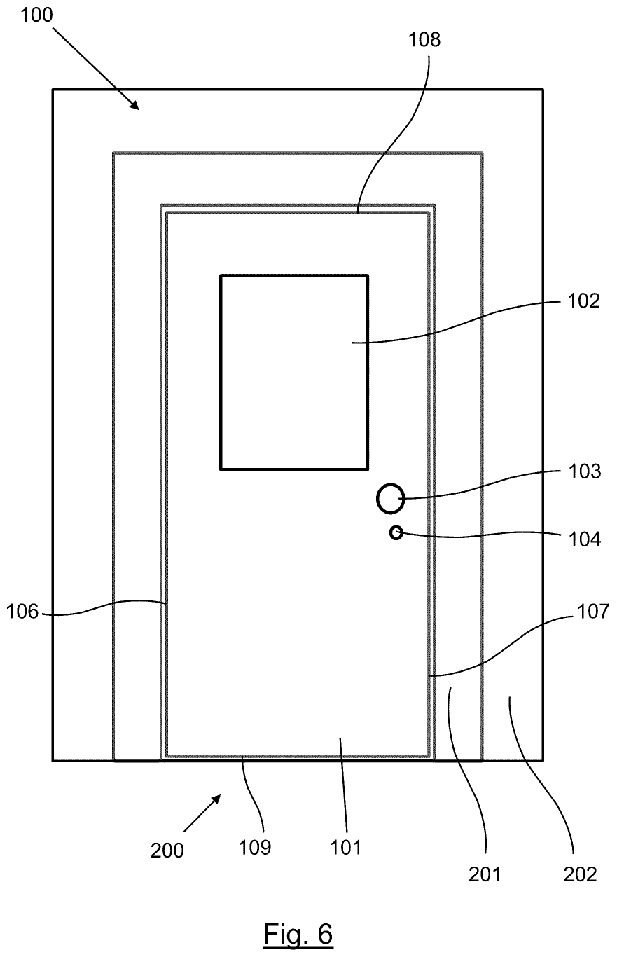

Finally, an architrave 201 is mounted to the wall 202 (step 506), hiding the door liner 300 and edge of the wall 202 adjacent to the doorway 200, as shown in FIG. 6. As the door alignment tools 400 have been removed prior to installation of the architrave 201, and there are no brackets or the like extending from the door liner 300 or doorway 200, a standard architrave can be used, and no recess on the back of the architrave 201 is required, meaning a standard architrave can be used.

While the present invention has been described and illustrated with reference to particular embodiments, it will be appreciated by the person skilled in the art that the invention lends itself to many different variations not specifically illustrated herein. By way of example only, certain possible variations will now be described.

While in the embodiments described above there are two door alignment tools and corresponding sets of bores on each side of the door liner, in other embodiments there may be more or fewer door alignment tools and corresponding sets of bores. There may be one or more door alignment tools and corresponding sets of bores on the top edge of the door liner.

The number and position of door alignment tools and corresponding sets of bores may be determined by the certification of the door. For example, a particular distance between the screws with which the door liner is mounted to the adjacent wall may be described in the certification of the door. As doors can be of different lengths, this means different numbers of screws may be required. A door alignment tool and corresponding set of bores may be provided for each screw required. In other embodiments, more or fewer door alignment tools and corresponding sets of bores may be provided than screws are required. In other embodiments, more or fewer door alignment tools may be provided than there are sets of bores.

Even where a door alignment tool and corresponding set of bores is provided for each screw required, in practice an installer can choose only some and not all of the door alignment tools provided.

In other embodiments, the door set includes two doors arranged to be movably mounted to opposite sides of the door liner. Particularly in this case, due to the increased length of the top of the door liner, there may be one or more door alignment tools and corresponding sets of bores on the top edge of the door liner.

Particularly in embodiments in which the door set includes two doors, the doors may be removed from the door liner prior to the door liner being mounted to the wall, and re-attached afterwards. In this case, during installation a brace may be attached to the door liner for strength, which is removed before the doors are re-attached.

In other embodiments, the door set includes bracings to hold the door in the closed position for at least part of the door installation process.

In other embodiments, no packing material may be used.

In some embodiments, initially the door alignment tools are secured on only one side of the door liner, namely the side on which the door is hinged, and the door liner is secured to the wall on that side. The door alignment tools are then removed, and door alignment tools are then secured on the other side of the door liner, which is then secured to the wall on that side. In this way, the installer is able to pass open the door during installation, so they can access the other side.

While the door alignment tool is described as being secured to the door liner and the wall by screws, any other suitable removable fixing means could be used, such as nails or bolts. The alignment fixing and/or the securement fixing could comprise one hole, two holes, or any other suitable number of holes. One or more pins or barbs extending from the base plate of the door alignment tool, for example, could be used instead of one or more holes, for the alignment fixing and/or the securement fixing. The alignment fixing and/or the securement fixing could comprise a non-permanent adhesive.

The door alignment tool could comprise one prong, three prongs, or any other suitable number of prongs. The prongs could be tapered. The prongs could be grooved or shaped so that they are arranged to interlock with a complementarily shaped bore. The prongs and corresponding bores could be oval.

The base plate of the door alignment tool could be any other suitable shape other than rectangular.

The bores could be provided in the wall, so that the door alignment tool is secured to the wall using the prongs and the securement fixing, and then the alignment fixing is used to align the door alignment tool with respect to the door liner.

The door alignment tool may be made of metal, for example steel, or plastic, or any other suitable durable rigid material.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A door set for installation in a doorway in a wall, comprising:
a door liner arranged to be mounted by its outer edges to the wall adjacent the doorway, and further arranged to have a door movably mounted to an inner edge;
at least one door alignment tool, comprising:
a base plate;
at least one prong extending from a face of the base plate; and
at least one alignment fixing on the base plate;
wherein the at least one prong is arranged to be inserted into a corresponding at least one bore in one of the door liner and the wall, and wherein the door alignment tool is arranged to be removably and adjustably secured to the other of the door liner and the wall adjacent the doorway using the alignment fixing.

2. The door set of claim 1, further comprising a door movably mounted to the inner edge of the door liner.

3. The door set of claim 1, wherein the at least one door alignment tool further comprises a second prong extending from the face of the base plate, wherein the second prong is arranged to be inserted into a corresponding second bore in the one of the door liner and the wall.

4. The door set of claim 1, wherein the door alignment tool further comprises a securement fixing on the base plate, wherein the door alignment tool is arranged to be removably secured to the one of the door liner and the wall using the securement fixing.

5. The door set of claim 4, wherein the door alignment tool comprises two prongs, and wherein the securement fixing is located between the prongs.

6. The door set of claim 4, wherein the securement fixing comprises a hole in the base plate through which the door alignment tool is arranged to be removably secured to the one of the door liner and the wall by a screw.

7. The door set of claim 1, wherein the alignment fixing comprises at least one hole in the base plate through which the door alignment tool is arranged to be removably and adjustably secured to the other of the door liner and the wall by a screw.

8. The door set of claim 7, wherein the at least one hole is an elongate slot.

9. The door set of claim 8, wherein the alignment fixing further comprises a second elongate hole, and wherein the elongate axis of the first elongate slot is at a non-zero angle with respect to the elongate axis of the second elongate slot.

10. The door set of claim 1, wherein the at least one prong is adjacent a first end of the base plate, and the at least one an alignment fixing is adjacent a second end of the base plate.

11. The door set of claim 1, wherein the door liner comprises the at least one bore.

12. The door set of claim 1, wherein the door set comprises a plurality of door alignment tools.

13. A method of installing the door set of claim 1 in a doorway in a wall, comprising the steps of:
inserting the at least one prong of the at least one door alignment tool into the corresponding at least one bore in the one of the door liner and the wall;
removably securing the door alignment tool to the other of the door liner and the wall using the at least one alignment fixing;
positioning the door liner with respect to the wall using the at least one alignment fixing;
mounting the outer edge of the door liner to the wall; and
removing the at least one door alignment tool from the door liner and the wall.

14. The method of claim 13, wherein the door set further comprises a door, and wherein the step of positioning the door liner with respect to the wall comprises:
positioning the door liner and the door within the doorway such that a gap exists between the door liner and the door; and
aligning the door liner and the door and such that the gap between the door liner and door is of uniform width.

15. The method of claim 13, wherein the door alignment tool further comprises a securement fixing, and wherein the method comprises, subsequent to the step of inserting the at least one prong of the at least one door alignment tool, the step of:
removably securing the door alignment tool to the one of the door liner and the wall using the securement fixing.
